(19) United States
(12) Patent Application Publication
(10) Pub. No.: US 2017/0269916 A1
(43) Pub. Date: Sep. 21, 2017

(54) Selective Application Installation Or Application Running Without Installation

(71) Applicant: Microsoft Technology Licensing, LLC, Redmond, WA (US)

(72) Inventor: Rajat Singhal, Hyderabad (IN)

(73) Assignee: Microsoft Technology Licensing, LLC, Redmond, WA (US)

(21) Appl. No.: 15/075,999

(22) Filed: Mar. 21, 2016

(51) Int. Cl. G06F 9/445

(52) U.S. Cl. CPC G06F 8/61

(57) ABSTRACT

Multiple different applications are available to a user's device from an application store that is accessed via a network. The applications can be selected for download and installation at the user's device, or alternatively can be selected for running without installation at the user's device. This selection is made by the user, giving the user control over whether an application is installed on the user's device or run without installation at the user's device. When selected for running without installation at the user's device, the application is run on one of multiple different virtual machines that corresponds to the form factor of the user device. A user interface generated by the application running on the virtual machine is provided to the user device for display, and user inputs at the user device are returned to the virtual machine for input to the application running on the virtual machine.

### BACKGROUND

As computing technology has advanced, various different types of computing devices have become commonplace in our lives. For example, smart phones, tablets, phablets, and so forth are used by many people. Many of the applications available to the users to run on these devices are available for download via an online application store, and users access the application store via the Internet. While such application stores provide a wide variety of different applications for users, they are not without their problems. One such problem is that numerous different applications providing similar functionality may be available, and it can be difficult for users to pick which application is the one they want. This can lead to user frustration and dissatisfaction with their devices and with the application store.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

In accordance with one or more aspects, for one of multiple applications that can be obtained from an application store, a first option to install the one application on a user device and a second option to run the one application without installing the one application on the user device are provided. A user selection of the second option for the one application is received. In response to the user selection of the second option, the one application is run on a virtual machine without installing the one application on the user device. Running the application on the virtual machine includes receiving data describing a user interface display from the one application on the virtual machine and providing the data to the user device for presentation of the user interface display at the user device, and receiving, from the user device, data describing user input to the user interface display and providing the data describing the received user input to the one application running on the virtual machine.

In accordance with one or more aspects, an application store is implemented on one or more computing devices. The application store includes a selective application installation system storing instructions configured to provide, to a user device for one of multiple applications that can be obtained from the application store a first option to install the one application on a user device and a second option to run the one application without installing the one application on the user device. The application store also includes a virtual machine facilitation module storing instructions configured to, in response to user selection of the second option, facilitate running of the one application on a virtual machine without installing the one application on the user device. The application store also includes an application installation module storing instructions configured to, in response to user selection of the first option, provide the one application to the user device for installation on the user device.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different instances in the description and the figures may indicate similar or identical items. Entities represented in the figures may be indicative of one or more entities and thus reference may be made interchangeably to single or plural forms of the entities in the discussion.

FIG. 1 illustrates an example system implementing the selective application installation or application running without installation in accordance with one or more embodiments.

FIG. 2 illustrates an example display supporting the selective application installation or application running without installation discussed herein.

FIG. 3 illustrates an example system in additional detail implementing the selective application installation or application running without installation in accordance with one or more embodiments.

FIG. 4 is a flowchart illustrating an example process for implementing the selective application installation or application running without installation in accordance with one or more embodiments.

FIG. 5 illustrates an example system that includes an example computing device that is representative of one or more systems and/or devices that may implement the various techniques described herein.

### DETAILED DESCRIPTION

Selective application installation or application running without installation is discussed herein. Multiple different applications are available to a user's device from an application store that is accessed via a network. The applications in the application store can be selected for download and installation at the user's device, or alternatively can be selected for running without installation at the user's device. This selection is made by the user, giving the user control over whether an application is installed on the user's device or run without installation at the user's device.

To support running the application without installation at the user's device, the application is installed on multiple different virtual machines. Each virtual machine is running on a computing device (e.g., a server) remote from the user's device. Such a computing device remote from the user's device refers to another computing device that is not the user's device (e.g., and is accessed via a network such as the Internet). Different ones of the multiple different virtual machines have installed on them different versions of the application for different user device form factors, such as one version for smartphones, one version for tablet devices, and one version for large-screen (e.g., television) devices. The different versions of an application as discussed herein refer to different versions of the application designed for different form factors (as opposed to different versions of an application that are upgrades or improvements to a previous version of the application). When selected for running without installation at the user's device, the application is run on the one of the multiple different virtual machines that corresponds to the form factor of the user device. A user interface generated by the application running on the virtual machine is provided to the user device for display, and user inputs at the user device are returned to the virtual machine for input to the application running on the virtual machine.

Running the application without installing the application on the user device allows the user to try the application prior to installing the application on his or her device. The user can see if he or she likes the application without installing the application on his or her device, and the time and bandwidth involved in downloading and installing the application on the user device is not expended. Further, any cost (e.g., financial cost) involved in using available bandwidth to download the application to the user device is saved. Additionally, any changes that would result from installation on the user device (e.g., configuration changes, permission changes, etc.) are not incurred. If the user decides he or she does like the application, then the application can be installed on his or her device. Thus, if a user desires to try twelve different programs to see which he or she likes best, the user can do so without needing to repeatedly download, install, run, and uninstall each of the twelve different programs on his or her device.

Furthermore, running the application without installing the application on the user device allows resources on the user device to be conserved. In some situations, the application may be resource intensive (e.g., require a large amount of processing power, a large amount of memory, etc.). In such situations, the application can be run on the virtual machine, alleviating the user device of the need for intensive resource expenditure to run the application. Similarly, in some situations the application may use resources that are unavailable on the user device (e.g., the user device may not have a fast enough processor or enough memory to run the application). In such situations, the application can be run on the virtual machine, allowing the application to be used by the user despite the user's device having insufficient resources to run the application.

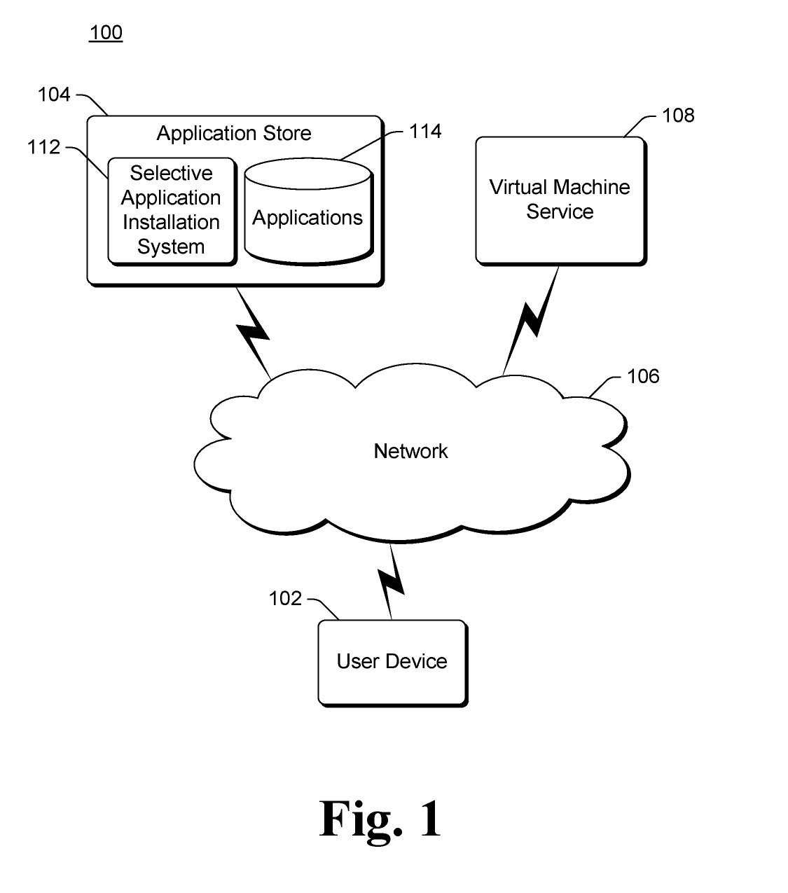

FIG. 1 illustrates an example system 100 implementing the selective application installation or application running without installation in accordance with one or more embodiments. System 100 includes a user device 102 that can communicate with an application store 104 via a network 106. Network 106 can be a variety of different networks, including the Internet, a local area network (LAN), a public telephone network, an intranet, other public and/or proprietary networks, combinations thereof, and so forth.

The computing device 102 can be a variety of different types of devices, such as a desktop computer, a server computer, a laptop or netbook computer, a mobile device (e.g., a tablet or phablet device, a cellular or other wireless phone (e.g., a smartphone), a notepad computer, a mobile station), a wearable device (e.g., eyeglasses, head-mounted display, watch, bracelet), an entertainment device (e.g., an entertainment appliance, a set-top box communicatively coupled to a display device, a game console), Internet of Things (IoT) devices (e.g., objects or things with software, firmware, and/or hardware to allow communication with other devices), a television or other display device, an automotive computer, and so forth. Thus, the computing device 102 may range from a full resource device with substantial memory and processor resources (e.g., personal computers, game consoles) to a low-resource device with limited memory and/or processing resources (e.g., traditional set-top boxes, hand-held game consoles).

The application store 104 is implemented as one or more of a variety of different types of devices. In one or more embodiments, the application store 104 is implemented as one or more server computers. Additionally or alternatively, similar to the discussion of computing device 102, the application store 104 can be implemented as one or more of a variety of different types of devices, ranging from full resource devices with substantial memory and processor resources to low-resource devices with limited memory and/or processing resources.

The system 100 also includes a virtual machine service 108. In one or more embodiments, the virtual machine service 108 is implemented as one or more server computers. Additionally or alternatively, similar to the discussion of computing device 102, the virtual machine service 108 can be implemented as one or more of a variety of different types of devices, ranging from full resource devices with substantial memory and processor resources to low-resource devices with limited memory and/or processing resources.

The application store 104 is a store or marketplace where applications can be purchased, downloaded, run, or otherwise obtained by the user device 102. The application store 104 includes a selective application installation system 112 and multiple applications 114. The applications 114 are various different applications (also referred to as programs) that can be installed and run on the user device 102. The applications 114 can be any of a variety of different types of applications providing any of a variety of different functionality, such as games or other entertainment applications, audio and/or video playback applications, productivity applications (e.g., word processing applications, spreadsheet applications, database applications), utility applications, and so forth.

The selective application installation system 112 supports user selection to install applications 114 on the user device 102 or run the applications 114 without installation on the user device 102. In response to a user selection to install an application 114 on the user device 102, the application 114 is downloaded to the user device 102 via the network 106 and installed on the user device 102. This installation of the application 114 on the user device 102 can include various different operations, such as decompressing instructions or data, storing instructions or data in particular files or folders, updating various system configuration settings, obtaining or setting particular system permissions (e.g., to receive location information regarding the user device 102, to access a camera or microphone of the user device 102, etc.), and so forth.

In response to user selection to run an application 114 without installing the application 114 on user device 102, the selective application installation system 112 accesses a virtual machine of the virtual machine service 108. In one or more embodiments, multiple different virtual machines are running in the virtual machine service 108 for different user device form factors. Given that a large number of different applications 114 may be supported by the application store 104, it should be noted that multiple different virtual machines can be running in the virtual machine service 108 for the same device form factor.

The form factor of a user device refers to the manner in which data is displayed by the user device and/or the manner in which user inputs are received at the user device. This can include different sizes of screens or displays (e.g., small screens like smartphones, medium-sized screens like tablet devices, and large-sized screens like televisions), different types of screens or displays (e.g., touchscreens, non-touchscreens, virtual reality or augmented reality displays), and/or different types of supported input mechanisms (e.g., touchscreens, cursor control devices, audio inputs). The application 114 developer can design different versions of the application 114 for different form factors—which different form factors versions of the application 114 are for is a decision made by the application 114 developer. Additionally or alternatively, an application 114 may have a single version, in which case the application 114 is a single or universal application that is configured to work with multiple different form factors.

The different versions of the application 114 are installed on different virtual machines of the virtual machine service 108. In one or more embodiments, this installation is done prior to user selection to run the application 114 without installation on the user device 102. For example, the application 114 can be installed on the virtual machine as part of publishing or otherwise making the application 114 available to the user device 102 via the application store 104. Alternatively, the installation of the application 114 on a virtual machine of the virtual machine service 108 can be done in response to user selection to run the application without installation on the user device 102.

The selective application installation system 112 runs the application 114 on a virtual machine of the virtual machine service 108 that corresponds to the form factor of the user device 102. Thus, for example, if the user device 102 is a smartphone then a version of the application 114 designed for smartphone displays (e.g., small displays that are touchscreens) is run on a virtual machine of the virtual machine service 108, but if the user device 102 is a television then a version of the application 114 designed for large-sized displays and cursor control devices is run on a virtual machine of the virtual machine service 108. In one or more embodiments, an application 114 may have a single (e.g., universal) form factor, in which case the same version of the application 114 is run regardless of the form factor of the user device 102.

In one or more embodiments, when running the application 114 on a virtual machine the virtual machine communicates with the user device 102 via the application store 104. An image(s) of the user interface (UI) generated by the application 114 is provided to the selective application installation system 112, which communicates the image(s) to the user device 102 for display on the user device 102. Similarly, user inputs to the application 114 (e.g., audio inputs, selection of particular screen locations (e.g., corresponding to displayed buttons or menu items), text inputs) are received at the user device 102 and communicated to the selective application installation system 112, which in turn communicates the user inputs to the application 114 running on the virtual machine. The application 114 then processes the inputs as appropriate, optionally performing various actions or operations based on the inputs and/or other programming of the application, and optionally updating the image(s) that are provided to the selective application installation system 112 and communicated to the user device 102.

In one or more embodiments, communications between the selective application installation system 112 and the virtual machine of the virtual machine service 108 are routed through the network 106. Additionally or alternatively, the selective application installation system 112 can be communicatively coupled to the virtual machine of the virtual machine service 108 via other wired or wireless connections, such as a USB (universal serial bus) connection, a wireless USB connection, an infrared connection, a Bluetooth connection, a DisplayPort connection, a PCI (a peripheral component interconnect) Express connection, and so forth.

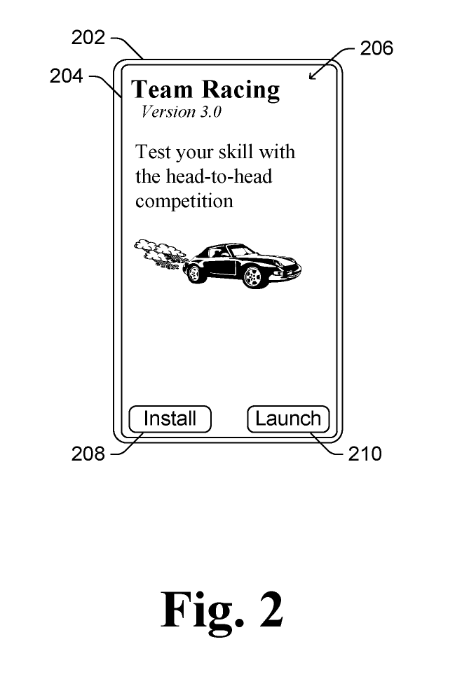

FIG. 2 illustrates an example display supporting the selective application installation or application running without installation discussed herein. A user device 202 is illustrated having a touchscreen display 204. The user device 202 is, for example, a user device 102 of FIG. 1. A description 206 of an example entertainment application that is a racing game titled “Team Racing” is displayed on the touchscreen display 204. The description 206 is displayed by an application on the user device 202 that allows communication with and display of information from the application store 104 of FIG. 1, such as an application designed and configured to communicate with the application store 104 or a Web browser. User selectable buttons 208 and 210 are also displayed on the touchscreen display 204. The user selectable button 208 corresponds to installing the application on the user device 202. In response to user selection (e.g., touching) of the user selectable button 208, the “Team Racing” application is downloaded and installed on the user device 202. The user selectable button 210 corresponds to running the application without installing the application on the user device 202. In response to user selection (e.g., touching) of the user selectable button 210, the “Team Racing” application is run on a virtual machine and without installation on the user device 202.

Although two user selectable options (installing the application and running the application without installing the application on the user device 202) are illustrated in FIG. 2, it should be noted that any of a variety of other options can also be made available for selection by the user. For example, a user selectable share option may be displayed allowing the user to notify other users of the example entertainment application, a view option may be displayed allowing the user to view sample screen shots from the example entertainment application, a review option may be displayed allowing the user to read reviews of the example entertainment application posted by other users, and so forth.

Returning to FIG. 1, it should be noted that the user selectable buttons 208 and 210 of FIG. 2 are examples of the manner in which user selection to install an application on the user device 102 or run an application without installation on the user device 102 can be made. Additionally or alternatively, the user selection to install an application on the user device 102 or run an application without installation on the user device 102 can be made in various other manners, such as user selection from a pull-down menu, user selection of a displayed link, user selection of a particular button on a remote control device associated with the user device 102, audible command inputs, and so forth.

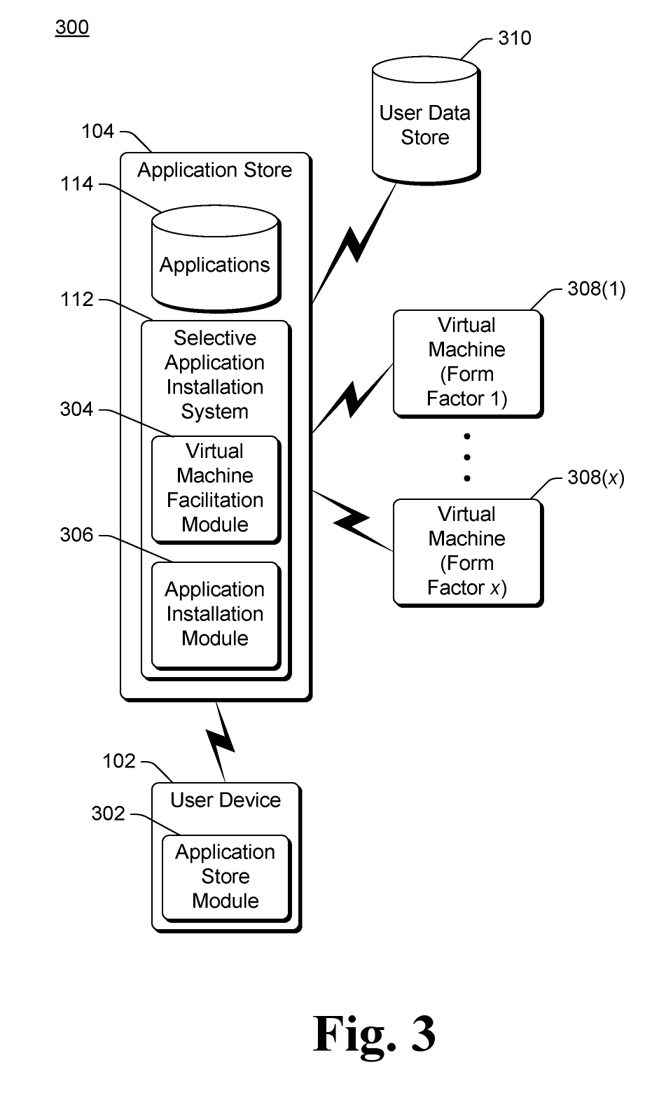

FIG. 3 illustrates an example system 300 in additional detail implementing the selective application installation or application running without installation in accordance with one or more embodiments. System 300 includes the user device 102 and the application store 104 that can communicate with one another via various different networks as discussed above. The application store 104 includes applications 114 and selective application installation system 112 as discussed above.

The user device 102 includes an application store module 302 that provides a user interface for the application store 104. The application store module 302 allows descriptions of the applications 114 to be displayed on the user device 102, receives user selections to install an application 114 on the user device 102 and/or run an application 114 without installation on the user device 102, receives user inputs to search for or otherwise select particular applications 114 (e.g., by specifying search terms or other search criteria), and so forth. The application store module 302 communicates with the application store 104, providing indications of user inputs to the application store 104, and receiving information to be displayed or otherwise presented by the user device 102.

The application store module 302 can be implemented in a variety of different manners. In one or more embodiments, the application store module 302 is itself an application that is designed and configured to communicate with the application store 104. Additionally or alternatively, the application store module 302 is a Web browser or other Web application designed to communicate with various different services or systems over a network, including the application store 104.

For each of the applications 114, a user selection to install the application on the user device 102 (e.g., user selection of the install button 208 of FIG. 2) or to run the application without installation on the user device 102 (e.g., user selection of the launch button 210 of FIG. 2) is received. The user interface allowing user selection to install the application on the user device 102 or to run the application without installation on the user device 102 can be provided by the application store module 302 and/or the application store 104 (e.g., by the selective application installation system 112). This selection is made via the application store module 302. Thus, for example, the description 206 of the example entertainment application is displayed by the application store module 302.

The selective application installation system 112 includes a virtual machine facilitation module 304 and an application installation module 306. The virtual machine facilitation module 304 facilitates running of an application 114 without installing the application 114 on the user device 102. Generally, the virtual machine facilitation module 304 selects a virtual machine on which the application is run, and operates to route data between the virtual machine and the user device 102.

The application store 104 has access to multiple (x) virtual machines 308(1), . . . , 308(x). Different ones of the virtual machines 308(1), . . . , 308(x) correspond to (and are configured as) a different form factor as discussed above, and run a version of an application 114 designed for the corresponding form factor. Although individual virtual machines 308 are illustrated for each of multiple different form factors, it should be noted that multiple virtual machines 308 can correspond to (and be configured as) the same form factor. The virtual machines 308(1), . . . , 308(x) can be implemented on the same or different computing devices. A virtual machine refers to a software implementation of a physical computing device (or other machine or system) that can run programs analogous to a physical computing device. The virtual machine includes one or more virtual components that are similar to (but are software implementations of) the physical components of a computing device (e.g., processors, storage devices, communication interfaces, and so forth). An operating system as well as other applications can execute using the virtual components as they would using the physical components, including running on virtual processors or virtual processor cores, accessing virtual memory, and so forth. The operating system and other applications executing in the virtual machine need have no knowledge, and typically have no knowledge, that they are executing in a virtual machine. The running of the virtual machine, including accessing of appropriate physical components to carry out operations being performed on the virtual components, is managed by a virtual machine monitor or hypervisor.

Although discussed herein as virtual machines, it should be noted that an application can be run without being installed on the user device 102 using other techniques. For example, rather than computing devices running virtual machines, one or more computing devices can run an emulator that causes the one or more computing devices to operate or behave as a particular type of computing device, such as a computing device having a particular form factor.

In one or more embodiments, the version of the application that is run on a virtual machine 308(1), . . . , 308(x) is the version of the application having the same form factor as the user device 102. The form factor of the user device 102 can be obtained by the virtual machine facilitation module 304 in a variety of different manners, such as from the user device 102 itself, from a user of the user device 102, from a previously provided configuration setting (e.g., associated with a user identifier maintained by the application store 104), and so forth.

Additionally or alternatively, the version of the application that is run on a virtual machine 308(1), . . . , 308(x) is a version of the application for a form factor specified by the user device 102 and/or the user of the user device 102 regardless of whether that specified form factor is the same as the form factor of the user device 102. This specification of a form factor can be provided to the virtual machine facilitation module 304 in a variety of different manners, such as user selection of a menu item displayed on the user device 102, user preference or configuration settings previously provided to the application store module 302 or the application store 104, and so forth. This allows, for example, a user to select and test a version of the application for a form factor other than the form factor of the user device 102. It should be noted, however, that in some situations the application may not provide a display in a user friendly manner, or accept all inputs, because the version of the application is for a form factor other than the form factor of the user device 102. For example, if the user device 102 does not support touchscreen inputs, but the form factor selected by the user is a smartphone form factor that supports touchscreen inputs, then the application may not receive user inputs as intended by the application (because the user device 102 does not allow for touchscreen inputs).

The virtual machine facilitation module 304 operates as an intermediary between the virtual machine 308 running the application and the user device 102. The application runs on the virtual machine 308, and a component of the virtual machine 308 (e.g., a user interface component) provides data describing a user interface presentation (e.g., display images, audio for playback) to the virtual machine facilitation module 304 rather than on a display, speakers, etc. of the computing device implementing the virtual machine 308. The data can be, for example, an image to be displayed as part of the UI. The virtual machine facilitation module 304 communicates the received data to the application store module 302, which displays, plays back, or otherwise presents the data at the user device 102. Thus, the images, audio, and so forth that would be presented to the user if he or she were running the application on the user device 102 are presented to the user despite the application being run on one of the virtual machines 308(1), . . . , 308(x).

Additionally, various user inputs can be provided to the user device while the application is being run by the virtual machine. These user inputs can be selections of various menu items or buttons, inputs of cursor controls or physical keys, audible inputs, motion inputs (e.g., rotating or moving the user device 102), and so forth. The application store module 302 collects data describing these user inputs and communicates the collected data to the virtual machine facilitation module 304. The data collected varies based on the type of user input, and can be, for example, data describing touchscreen locations that are touched by the user, recorded audio input by the user, data describing what cursor control was made or physical keys were touched, data describing movement or motion (e.g., speed, angle, distance, etc.) of the user device 102, and so forth. The virtual machine facilitation module 304 forwards the collected data received from the application store module 302 to the virtual machine 308 running the application. The application reacts to the user input in a manner dependent on the particular user input. For example, the application can identify a button or object that was selected or activated by the user due to the user touching a particular location on the touchscreen of the user device 102, perform a particular operation based on the audio input by the user, change what image is displayed based on the movement of the user device 102, and so forth.

Changes to the display or other presentation of information or data by the application in response to the user input (or based on other operation of the application) are provided to the virtual machine facilitation module 304 for communication to the application store module 302, such as new images to display, new audio to play back, and so forth. This providing of user inputs and changing of the information or data displayed due (in response to the user inputs or simply the running of the application) continues until running of the application is terminated. Running of the application can be terminated in any of a variety of different manners, such as the application itself deciding to terminated running, the user of the user device 102 inputting a command to stop the application from running (e.g., an “exit” or “close” command), the user of the user device 102 switching to run a different application (e.g., in situations in which the user device 102 runs only one program at a time), and so forth. In response to the determination to terminate running the application (received by the virtual machine facilitation module 304 from the application store module 302 and provided to the virtual machine 308), the virtual machine 308 stops running the application for that user (other users may continue to run the application).

Thus, a user interface is presented to the user of the user device 102 for the application as if the application were running on the user device 102. Images are displayed to the user, audio is played back to the user, and so forth. The user of the user device 102 can further interact with the application and provide various different inputs that the application responds to. The processing resources (e.g., processors, memory, etc.) to run the application, however, are expended on the computing device implementing the virtual machine rather than the user device 102. The user device 102 displays or otherwise presents the user interface, and receives user inputs, but does not perform the functionality of the application (the virtual machine performs the functionality of the application).

The selective application installation system 112 also includes the application installation module 306. The application installation module 306 facilitates installation of the application 114 on the user device 102. The application installation module 306 provides to the user device 102 the various files and/or other data used to install the application 114 on the user device 102. One or more components on the user device 102, such as the application store module 302 and/or an operating system of the user device 102, installs the application 114 on the user device 102. This installation of the application 114 on the user device 102 can include various different operations as discussed above, such as decompressing instructions or data, storing instructions or data in particular files or folders, updating various system configuration settings, obtaining or setting particular system permissions, and so forth. It should be noted that an application 114 installed on the user device 102 can have been previously run on a virtual machine 308 for the user of the user device 102 without installation on the user device 102, or alternatively may not have been previously run on a virtual machine 308 for the user of the user device 102.

In one or more embodiments, the user of the user device 102 has a user identifier that is associated with the application store 104. This user identifier allows the application store 104 to distinguish the user of the user device 102 from other users of the application store 104. The user identifier can be associated with the particular user device 102, or alternatively can be independent of the user device 102 (e.g., the user may have multiple different user devices that he or she uses to access the application store 104 and may use the same user identifier for all of these different devices). In one or more embodiments the user identifier is a user identifier that the user of the user device 102 uses (e.g., along with a password or other credentials) to log into the application store 104.

In one or more embodiments, the system 300 includes a user data store 310 that maintains user data for the user of the user device 102. This user data is maintained as associated with the user identifier of the user of the user device 102, allowing the user data to be readily obtained from the user data store 310 given the user identifier. In one or more embodiments, each of the applications 114 also has an application identifier that allows the application store 104 to distinguish the application from the other applications 114. A combination of the user identifier and the application identifier allows application data specific to a particular user of a particular application to be maintained and readily obtained from the user data store 310. The user data maintained in the user data store 310 can take various forms, such as gameplay data for an application, configuration data for an application, personalization data for the user and/or an application, and so forth.

In one or more embodiments, the selective application installation system 112 allows user data to be retrieved from the user data store 310 and used when a user runs an application without installing the application on the user device 102. For example, as part of starting running of an application on a virtual machine 308(1), . . . , 308(x) for a particular user, the virtual machine facilitation module 304 can obtain the user data for that user for that application and provide the user data to the virtual machine 308(1), . . . , 308(x). This allows the virtual machine 308(1), . . . , 308(x) to run the application again based on the user data obtained during one or more previous runnings of the application (e.g., reflecting previous gameplay data such as levels completed or achievements obtained, reflecting user configuration settings such as desired colors or languages, and so forth).

While running, the application can save additional user data, and can be configured to save the additional user data locally or in a cloud store (e.g., another storage device coupled to the network 106 of FIG. 1). For user data that is to be stored locally, the virtual machine 308 running the application provides the user data to the virtual machine facilitation module 304 (rather than to a local storage device of the virtual machine 308), which stores the user data in the user data store 310 as associated with a combination of the user identifier and the application identifier. For user data that is read by the application while running, the virtual machine 308 running the application requests the data from the virtual machine facilitation module 304 (rather than from a local storage device of the virtual machine 308), which retrieves from the user data store 310 the user data that is association with the combination of the user identifier (of the user that is running the application) and the application identifier. This user data in the user data store 310 can then be transferred to the user device 102 if the application is subsequently installed on the user device 102 as discussed in more detail below.

For user data that is to be stored in a cloud store, the virtual machine 308 running the application provides the user data to the virtual machine facilitation module 304 (rather than to a cloud store), which stores the user data in the user data store 310 as associated with a combination of the user identifier and the application identifier. For user data that is read by the application while running, the virtual machine 308 running the application requests the data from the virtual machine facilitation module 304 (rather than from a cloud store), which retrieves from the user data store 310 the user data that is associated with the combination of the user identifier (of the user that is running the application) and the application identifier. This user data in the user data store 310 can then be transferred to the cloud store if the application is subsequently installed on the user device 102 as discussed in more detail below.

Additionally or alternatively, if a user runs an application without installing the application on the user device 102 and subsequently decides to install the application on the user device 102, the user data maintained for the user for that application in the user data store 310 can also be downloaded to the user device 102. This allows, for example, configuration data already provided to the application to be maintained so that when the user runs the application installed on the user device 102 the application has the same configuration data as when the application was run on one of the virtual machines 308(1), . . . , 308(x). This also allows, for example, gameplay data accumulated for the application while the application was running on one of the virtual machines 308(1), . . . , 308(x) to be maintained for the application when installed on the user device 102. E.g., if the user achieved certain levels, achievements, credits or rewards, etc. while running the application on one of the virtual machines, those achieved levels, achievements, credits or rewards, etc. are automatically included as part of the application when installed on the user device 102.

The user data from the user data store 310 can be downloaded to the user device 102 for the application in a variety of different manners. In one or more embodiments, the user data is in a file or record that is known to and used by the application to store user data for the application. In such situations, the file or record is used to store the user data in the user data store 310, and the file or record is copied to the user device 102. Alternatively, an additional component on the user device 102, such as the application store module 302, can copy received user data from the user data store 310 via the application installation module 306, and update different files or records on the user device 102 to include the user data. These updated files or records are the files or records used by the application to store user data for the application.

Additionally or alternatively, user data that the application stores in a cloud store rather than on the user device 102 need not be downloaded to the user device 102. Rather, such user data can be copied to the cloud store used by the application. The user data can be copied to the cloud store in any of a variety of different manners analogous to the downloading of user data to the user device 102 (except that the data is copied to the cloud store rather than the user device 102).

In one or more embodiments, whether to download (or copy to a cloud store) user data accumulated during running of the application on a virtual machine 308(1), . . . , 308(x) is a user selectable option. Situations can arise, such as when the user desires to keep playing a game he or she already started playing, in which the user selects to have the user data accumulated during running of the application on a virtual machine 308(1), . . . , 308(x) downloaded to the user device 102 (or copied to a cloud store). Other situations can also arise, such as when a parent is testing a game for his or her child, in which the user selects not to have the user data accumulated during running of the application on a virtual machine 308(1), . . . , 308(x) downloaded to the user device 102 (or copied to a cloud store).

In one or more embodiments, the applications 114 include applications that are free—users need pay no fees to use (install and/or run without installing) free applications. Additionally or alternatively, applications 114 can include paid applications. Users pay a fee to use (install and/or run without installing) the paid application. An application can optionally include a trial version or particular portion (e.g., particular levels, particular functionality, etc.) that is available free but other versions or portions (e.g., including additional levels, additional functionality, etc.) can be available to the user if the fee is paid.

In situations in which a user has paid the fee to use a paid application, a record of the fee payment can be maintained by the application store 104 (e.g., as part of the user data store 310). This record of the fee payment can be maintained as associated with a combination of the user identifier and the application identifier, analogous to the discussion above for user data. In one or more embodiments, whether the user has paid the fee can be recorded as part of the user data for the application. If the user subsequently installs and/or runs without installing the paid application, the record that the fee payment has been made can be accessed by the application store 104 and no additional fee charged to the user. For example, a user may pay a fee for an application 114 that is run without being installed on the user device 102, and a few weeks or months later decide to install that application 114 on the user device 102, in which case the user need not re-pay the fee to install that application 114 on the user device 102.

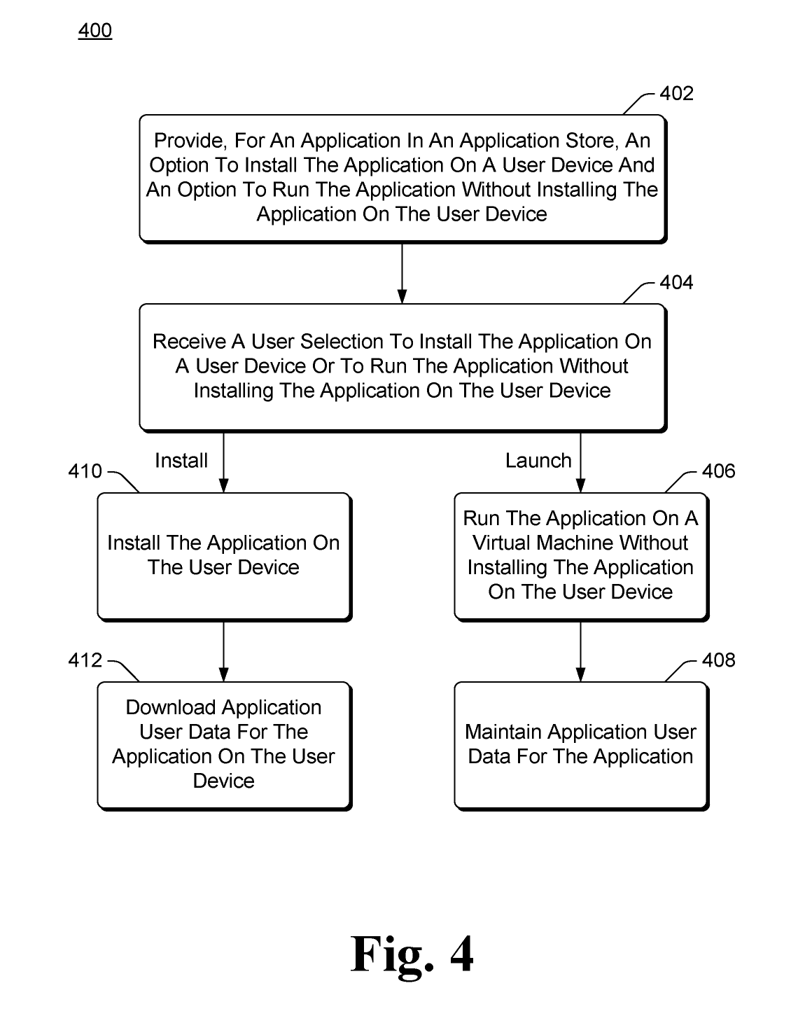

FIG. 4 is a flowchart illustrating an example process 400 for implementing the selective application installation or application running without installation in accordance with one or more embodiments. Process 400 is carried out by an application store, such as application store 104 of FIG. 1 or FIG. 3, and can be implemented in software, firmware, hardware, or combinations thereof. Process 400 is shown as a set of acts and is not limited to the order shown for performing the operations of the various acts. Process 400 is an example process for implementing the selective application installation or application running without installation; additional discussions of implementing the selective application installation or application running without installation are included herein with reference to different figures.

In process 400, for an application in the application store, an option to install the application on a user device and an option to run the application without installing the application on the user device is provided (act 402). These options are provided to a user device for display or other presentation to a user of the user device. The option to install the application is also referred to as an install option and can take various different forms (e.g., a button or menu item). The option to run the application without installing the application on the user device is also referred to as a launch option and can take various different forms (e.g., a button or menu item).

A user selection of the install option to install the application on the user device or the launch option to run the application without installing the application on the user device is received (act 404). The manner in which the user selection is received can vary, such as selection of a button, selection of a menu item, audio command input, and so forth.

In response to user selection of the launch option, the application is run on the virtual machine without installing the application on the user device (act 406). The application is run on a virtual machine corresponding to a particular form factor as discussed above, such as the form factor of the user device from which the launch selection was made. As part of running the application on the virtual machine, data describing a user interface display is received from the application and provided to the user device for presentation of the user interface display, and data describing user input to the user interface display is received from the user device and provided to the application running on the virtual machine.

User data for the application is optionally maintained (act 408). Various different user data, such as configuration data, gameplay data, and so forth can be maintained as discussed above. The user data is maintained in a user data store as corresponding to the application and the user of the user device, as discussed above.

Returning to act 404, in response to user selection of the install option, the application is downloaded to and installed on the user device (act 410). Various instructions, data, and so forth is copied to the user device and various changes made to the user device to install the application on the user device as discussed above.

User data for the application is also optionally downloaded to the user device (act 412). This user data is the user data maintained by the application when run on the virtual machine (e.g., the user data maintained in act 408). In one or more embodiments, whether the user data is downloaded to the application is a user selectable option as discussed above. Additionally or alternatively, the user data may be transferred to a cloud store rather than the user device as discussed above. It should also be noted that if there is no user data (e.g., the user selected to install the application without having previously run the application without installation on the user device), then no user data is downloaded for the application in act 412.

Although particular functionality is discussed herein with reference to particular modules, it should be noted that the functionality of individual modules discussed herein can be separated into multiple modules, and/or at least some functionality of multiple modules can be combined into a single module. Additionally, a particular module discussed herein as performing an action includes that particular module itself performing the action, or alternatively that particular module invoking or otherwise accessing another component or module that performs the action (or performs the action in conjunction with that particular module). Thus, a particular module performing an action includes that particular module itself performing the action and/or another module invoked or otherwise accessed by that particular module performing the action.

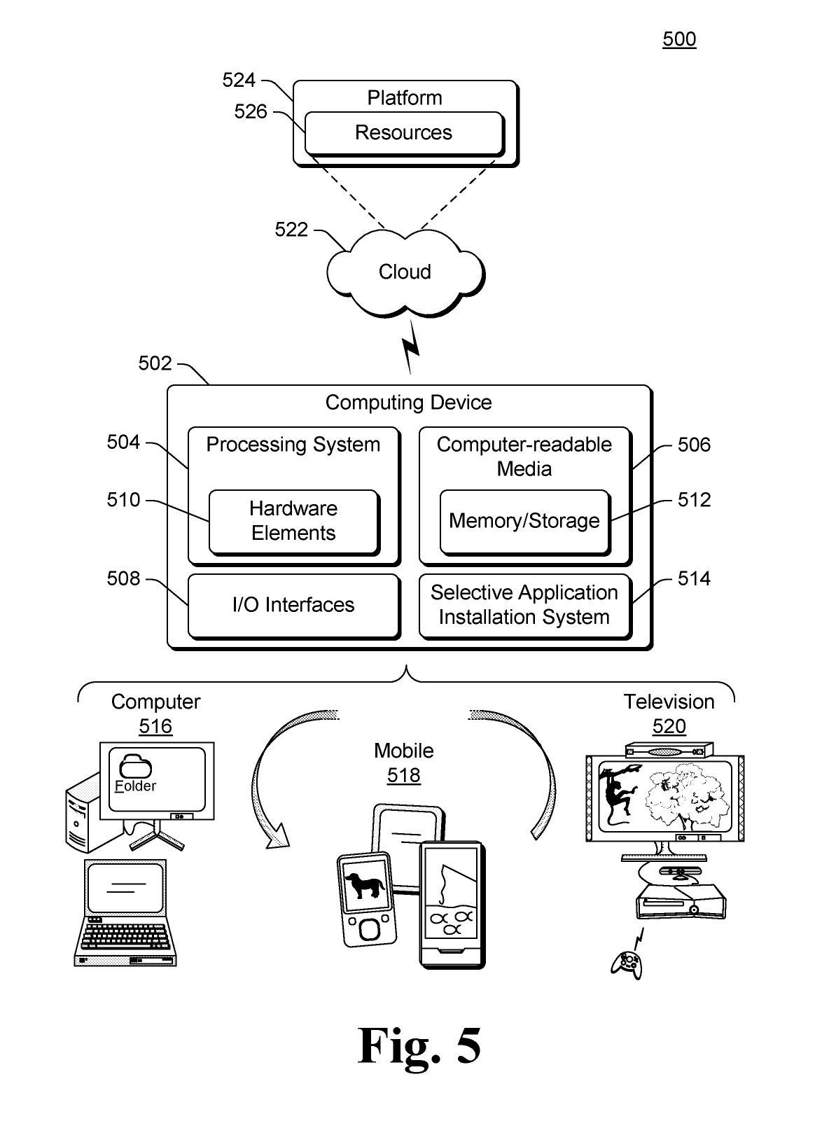

FIG. 5 illustrates an example system generally at 500 that includes an example computing device 502 that is representative of one or more systems and/or devices that may implement the various techniques described herein. The computing device 502 may be, for example, a server of a service provider, a device associated with a client (e.g., a client device), an on-chip system, and/or any other suitable computing device or computing system. The computing device 502 can be used to implement, for example, at least part of the application store 104 of FIG. 1 or FIG. 3, one or more virtual machines of the virtual machine service 108 of FIG. 1, or the user device 102 of FIG. 1 or FIG. 3.

The example computing device 502 as illustrated includes a processing system 504, one or more computer-readable media 506, and one or more I/O Interfaces 508 that are communicatively coupled, one to another. Although not shown, the computing device 502 may further include a system bus or other data and command transfer system that couples the various components, one to another. A system bus can include any one or combination of different bus structures, such as a memory bus or memory controller, a peripheral bus, a universal serial bus, and/or a processor or local bus that utilizes any of a variety of bus architectures. A variety of other examples are also contemplated, such as control and data lines.

The processing system 504 is representative of functionality to perform one or more operations using hardware. Accordingly, the processing system 504 is illustrated as including hardware elements 510 that may be configured as processors, functional blocks, and so forth. This may include implementation in hardware as an application specific integrated circuit or other logic device formed using one or more semiconductors. The hardware elements 510 are not limited by the materials from which they are formed or the processing mechanisms employed therein. For example, processors may be comprised of semiconductor(s) and/or transistors (e.g., electronic integrated circuits (ICs)). In such a context, processor-executable instructions may be electronically-executable instructions.

The computer-readable media 506 is illustrated as including memory/storage 512. The memory/storage 512 represents memory/storage capacity associated with one or more computer-readable media. The memory/storage 512 may include volatile media (such as random access memory (RAM)) and/or nonvolatile media (such as read only memory (ROM), Flash memory, optical disks, magnetic disks, and so forth). The memory/storage 512 may include fixed media (e.g., RAM, ROM, a fixed hard drive, and so on) as well as removable media (e.g., Flash memory, a removable hard drive, an optical disc, and so forth). The computer-readable media 506 may be configured in a variety of other ways as further described below.

The one or more input/output interface(s) 508 are representative of functionality to allow a user to enter commands and information to computing device 502, and also allow information to be presented to the user and/or other components or devices using various input/output devices. Examples of input devices include a keyboard, a cursor control device (e.g., a mouse), a microphone (e.g., for voice inputs), a scanner, touch functionality (e.g., capacitive or other sensors that are configured to detect physical touch), a camera (e.g., which may employ visible or non-visible wavelengths such as infrared frequencies to detect movement that does not involve touch as gestures), and so forth. Examples of output devices include a display device (e.g., a monitor or projector), speakers, a printer, a network card, tactile-response device, and so forth. Thus, the computing device 502 may be configured in a variety of ways as further described below to support user interaction.

In the illustrated example, the computing device 502 also includes a selective application installation system 514. The selective application installation system 514 provides various functionality supporting installing an application on a user device and/or running an application without installing the application on the user device as discussed above. The selective application installation system 514 can implement, for example, the selective application installation system 112 of FIG. 1 or FIG. 3. Alternatively, the selective application installation system 514 may not be included in the computing device. For example, if the computing device 502 implements one or more virtual machines of the virtual machine service 108 of FIG. 1, then the computing device 502 need not include the selective application installation system 514. By way of another example, if the computing device 502 implements the user device 102 of FIG. 1 or FIG. 3, then the computing device 502 need not include the selective application installation system 514.

Various techniques may be described herein in the general context of software, hardware elements, or program modules. Generally, such modules include routines, programs, objects, elements, components, data structures, and so forth that perform particular tasks or implement particular abstract data types. The terms “module,” “functionality,” and “component” as used herein generally represent software, firmware, hardware, or a combination thereof. The features of the techniques described herein are platform-independent, meaning that the techniques may be implemented on a variety of computing platforms having a variety of processors.

An implementation of the described modules and techniques may be stored on or transmitted across some form of computer-readable media. The computer-readable media may include a variety of media that may be accessed by the computing device 502. By way of example, and not limitation, computer-readable media may include “computer-readable storage media” and “computer-readable signal media.”

“Computer-readable storage media” refers to media and/or devices that enable persistent storage of information and/or storage that is tangible, in contrast to mere signal transmission, carrier waves, or signals per se. Thus, computer-readable storage media refers to non-signal bearing media. The computer-readable storage media includes hardware such as volatile and non-volatile, removable and non-removable media and/or storage devices implemented in a method or technology suitable for storage of information such as computer readable instructions, data structures, program modules, logic elements/circuits, or other data. Examples of computer-readable storage media may include, but are not limited to, RAM, ROM, EEPROM, flash memory or other memory technology, CD-ROM, digital versatile disks (DVD) or other optical storage, hard disks, magnetic cassettes, magnetic tape, magnetic disk storage or other magnetic storage devices, or other storage device, tangible media, or article of manufacture suitable to store the desired information and which may be accessed by a computer.

“Computer-readable signal media” refers to a signal-bearing medium that is configured to transmit instructions to the hardware of the computing device 502, such as via a network. Signal media typically may embody computer readable instructions, data structures, program modules, or other data in a modulated data signal, such as carrier waves, data signals, or other transport mechanism. Signal media also include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared, and other wireless media.

As previously described, the hardware elements 510 and computer-readable media 506 are representative of instructions, modules, programmable device logic and/or fixed device logic implemented in a hardware form that may be employed in some embodiments to implement at least some aspects of the techniques described herein. Hardware elements may include components of an integrated circuit or on-chip system, an application-specific integrated circuit (ASIC), a field-programmable gate array (FPGA), a complex programmable logic device (CPLD), and other implementations in silicon or other hardware devices. In this context, a hardware element may operate as a processing device that performs program tasks defined by instructions, modules, and/or logic embodied by the hardware element as well as a hardware device utilized to store instructions for execution, e.g., the computer-readable storage media described previously.

Combinations of the foregoing may also be employed to implement various techniques and modules described herein. Accordingly, software, hardware, or program modules and other program modules may be implemented as one or more instructions and/or logic embodied on some form of computer-readable storage media and/or by one or more hardware elements 510. The computing device 502 may be configured to implement particular instructions and/or functions corresponding to the software and/or hardware modules. Accordingly, implementation of modules as a module that is executable by the computing device 502 as software may be achieved at least partially in hardware, e.g., through use of computer-readable storage media and/or hardware elements 510 of the processing system. The instructions and/or functions may be executable/operable by one or more articles of manufacture (for example, one or more computing devices 502 and/or processing systems 504) to implement techniques, modules, and examples described herein.

As further illustrated in FIG. 5, the example system 500 enables ubiquitous environments for a seamless user experience when running applications on a personal computer (PC), a television device, and/or a mobile device. Services and applications run substantially similar in all three environments for a common user experience when transitioning from one device to the next while utilizing an application, playing a video game, watching a video, and so on.

In the example system 500, multiple devices are interconnected through a central computing device. The central computing device may be local to the multiple devices or may be located remotely from the multiple devices. In one or more embodiments, the central computing device may be a cloud of one or more server computers that are connected to the multiple devices through a network, the Internet, or other data communication link.

In one or more embodiments, this interconnection architecture enables functionality to be delivered across multiple devices to provide a common and seamless experience to a user of the multiple devices. Each of the multiple devices may have different physical requirements and capabilities, and the central computing device uses a platform to enable the delivery of an experience to the device that is both tailored to the device and yet common to all devices. In one or more embodiments, a class of target devices is created and experiences are tailored to the generic class of devices. A class of devices may be defined by physical features, types of usage, or other common characteristics of the devices.

In various implementations, the computing device 502 may assume a variety of different configurations, such as for computer 516, mobile 518, and television 520 uses. Each of these configurations includes devices that may have generally different constructs and capabilities, and thus the computing device 502 may be configured according to one or more of the different device classes. For instance, the computing device 502 may be implemented as the computer 516 class of a device that includes a personal computer, desktop computer, a multi-screen computer, laptop computer, netbook, and so on.

The computing device 502 may also be implemented as the mobile 518 class of device that includes mobile devices, such as a mobile phone, portable music player, portable gaming device, a tablet computer, a multi-screen computer, and so on. The computing device 502 may also be implemented as the television 520 class of device that includes devices having or connected to generally larger screens in casual viewing environments. These devices include televisions, set-top boxes, gaming consoles, and so on.

The techniques described herein may be supported by these various configurations of the computing device 502 and are not limited to the specific examples of the techniques described herein. This functionality may also be implemented all or in part through use of a distributed system, such as over a “cloud” 522 via a platform 524 as described below.

The cloud 522 includes and/or is representative of a platform 524 for resources 526. The platform 524 abstracts underlying functionality of hardware (e.g., servers) and software resources of the cloud 522. The resources 526 may include applications and/or data that can be utilized while computer processing is executed on servers that are remote from the computing device 502. Resources 526 can also include services provided over the Internet and/or through a subscriber network, such as a cellular or Wi-Fi network.

The platform 524 may abstract resources and functions to connect the computing device 502 with other computing devices. The platform 524 may also serve to abstract scaling of resources to provide a corresponding level of scale to encountered demand for the resources 526 that are implemented via the platform 524. Accordingly, in an interconnected device embodiment, implementation of functionality described herein may be distributed throughout the system 500. For example, the functionality may be implemented in part on the computing device 502 as well as via the platform 524 that abstracts the functionality of the cloud 522.

In the discussions herein, various different embodiments are described. It is to be appreciated and understood that each embodiment described herein can be used on its own or in connection with one or more other embodiments described herein. Further aspects of the techniques discussed herein relate to one or more of the following embodiments.

A method comprising: providing, for one of multiple applications that can be obtained from an application store, a first option to install the one application on a user device and a second option to run the one application without installing the one application on the user device; receiving a user selection of the second option for the one application; and running, in response to the user selection of the second option, the one application on a virtual machine without installing the one application on the user device, the running including: receiving data describing a user interface display from the one application on the virtual machine and providing the data to the user device for presentation of the user interface display at the user device, and receiving, from the user device, data describing user input to the user interface display and providing the data describing the received user input to the one application running on the virtual machine.

Alternatively or in addition to any of the above described methods, any one or combination of: the method further comprising identifying a form factor of the user device, selecting one of multiple virtual machines that correspond to the form factor of the user device, each of the multiple virtual machines corresponding to a different one of multiple user device form factors, and running the one application on the selected virtual machine; the providing further comprising displaying a first user selectable button as the first option, and displaying a second user selectable button as the second option; the method further comprising installing, in response to user selection of the first option, the application on the user device rather than running on the virtual machine; the method further comprising saving user data for the application running on the virtual machine as associated with both a user of the user device and the application; the method further comprising obtaining, when the application is again run on the virtual machine, the saved user data, and providing the saved user data to the application running on the virtual machine; the method further comprising obtaining, in response to user selection of the first option, the saved user data, and providing the saved user data to the application installed on the user device; the virtual machine running on a device remote from the user device.

An application store implemented on one or more computing devices, the application store comprising: a selective application installation system configured to provide, to a user device for one of multiple applications that can be obtained from the application store a first option to install the one application on a user device and a second option to run the one application without installing the one application on the user device; a virtual machine facilitation module configured to, in response to user selection of the second option, facilitate running of the one application on a virtual machine without installing the one application on the user device; and an application installation module configured to, in response to user selection of the first option, provide the one application to the user device for installation on the user device.

Alternatively or in addition to any of the above described application stores or computing devices, any one or combination of: the running of the one application on the virtual machine without installing the one application on the user device including receiving data describing a user interface display from the one application running on the virtual machine and providing the data to the user device for presentation of the user interface display at the user device, and receiving, from the user device, data describing user input to the user interface display and providing the data describing the received user input to the one application running on the virtual machine; the virtual machine facilitation module being further configured to determine a form factor of the user device, select one of multiple virtual machines that correspond to the form factor of the user device, each of the multiple virtual machines corresponding to a different one of multiple user device form factors, and run the one application on the selected virtual machine; the selective application installation system being configured to provide the first option as a first user selectable button, and provide the second option as a second user selectable button; the selective application installation system being further configured to save user data for the one application running on the virtual machine as associated with a user of the user device and the application; the virtual machine facilitation module being further configured to obtain, when the one application is again run on the virtual machine, the saved user data, and provide the saved user data to the one application running on the virtual machine; the virtual machine facilitation module being further configured to obtain, in response to user selection of the first option, the saved user data, and provide the saved user data to the one application installed on the user device.

A system comprising: one or more processors; one or more computer-readable storage media having stored thereon multiple instructions that, responsive to execution by the one or more processors, cause the one or more processors to perform acts comprising: providing, for one of multiple applications that can be obtained from an application store, a first option to install the one application on a user device and a second option to run the one application without installing the one application on the user device; receiving a user selection of the second option or the first option for the one application; running, in response to user selection of the second option, the one application on a virtual machine remote from the user device without installing the one application on the user device; and providing, in response to user selection of the first option, the application to the user device for installation on the user device.

Alternatively or in addition to any of the above described systems, any one or combination of: the running the one application on the virtual machine without installing the one application on the user device including receiving data describing a user interface display from the one application running on the virtual machine and providing the data to the user device for presentation of the user interface display at the user device, and receiving, from the user device, data describing user input to the user interface display and providing the data describing the received user input to the one application running on the virtual machine; the acts further comprising determining a form factor of the user device, selecting one of multiple virtual machines that correspond to the form factor of the user device, each of the multiple virtual machines corresponding to a different one of multiple user device form factors, and running the one application on the selected virtual machine; the acts further comprising saving user data for the one application running on the virtual machine as associated with a user of the user device and the one application; the acts further comprising obtaining, when the one application is again run on the virtual machine, the saved user data, and providing the saved user data to the one application running on the virtual machine; the acts further comprising obtaining, in response to user selection of the first option, the saved user data, and providing the saved user data to the one application installed on the user device.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A method comprising:
providing, for one of multiple applications that can be obtained from an application store, a first option to install the one application on a user device and a second option to run the one application without installing the one application on the user device;
receiving a user selection of the second option for the one application; and
running, in response to the user selection of the second option, the one application on a virtual machine without installing the one application on the user device, the running including:
receiving data describing a user interface display from the one application on the virtual machine and providing the data to the user device for presentation of the user interface display at the user device, and
receiving, from the user device, data describing user input to the user interface display and providing the data describing the received user input to the one application running on the virtual machine.

2. The method as recited in claim 1, further comprising:
identifying a form factor of the user device;
selecting one of multiple virtual machines that correspond to the form factor of the user device, each of the multiple virtual machines corresponding to a different one of multiple user device form factors; and
running the one application on the selected virtual machine.

3. The method as recited in claim 1, the providing further comprising displaying a first user selectable button as the first option, and displaying a second user selectable button as the second option.

4. The method as recited in claim 1, further comprising installing, in response to user selection of the first option, the application on the user device rather than running on the virtual machine.

5. The method as recited in claim 1, further comprising saving user data for the application running on the virtual machine as associated with both a user of the user device and the application.

6. The method as recited in claim 5, further comprising:
obtaining, when the application is again run on the virtual machine, the saved user data; and
providing the saved user data to the application running on the virtual machine.

7. The method as recited in claim 5, further comprising:
obtaining, in response to user selection of the first option, the saved user data; and
providing the saved user data to the application installed on the user device.

8. An application store implemented on one or more computing devices, the application store comprising:
a selective application installation system configured to provide, to a user device for one of multiple applications that can be obtained from the application store a first option to install the one application on a user device and a second option to run the one application without installing the one application on the user device;
a virtual machine facilitation module configured to, in response to user selection of the second option, facilitate running of the one application on a virtual machine without installing the one application on the user device; and
an application installation module configured to, in response to user selection of the first option, provide the one application to the user device for installation on the user device.

9. The application store as recited in claim 8, the running of the one application on the virtual machine without installing the one application on the user device including:
receiving data describing a user interface display from the one application running on the virtual machine and providing the data to the user device for presentation of the user interface display at the user device; and
receiving, from the user device, data describing user input to the user interface display and providing the data describing the received user input to the one application running on the virtual machine.

10. The application store as recited in claim 8, the virtual machine facilitation module being further configured to:
determine a form factor of the user device;
select one of multiple virtual machines that correspond to the form factor of the user device, each of the multiple virtual machines corresponding to a different one of multiple user device form factors; and
run the one application on the selected virtual machine.

11. The application store as recited in claim 8, the selective application installation system being configured to provide the first option as a first user selectable button, and provide the second option as a second user selectable button.

12. The application store as recited in claim 8, the selective application installation system being further configured to save user data for the one application running on the virtual machine as associated with a user of the user device and the application.

13. The application store as recited in claim 12, the virtual machine facilitation module being further configured to:
obtain, when the one application is again run on the virtual machine, the saved user data; and
provide the saved user data to the one application running on the virtual machine.

14. The application store as recited in claim 12, the virtual machine facilitation module being further configured to:
obtain, in response to user selection of the first option, the saved user data; and
provide the saved user data to the one application installed on the user device.

15. A system comprising:
one or more processors;
one or more computer-readable storage media having stored thereon multiple instructions that, responsive to execution by the one or more processors, cause the one or more processors to perform acts comprising:
providing, for one of multiple applications that can be obtained from an application store, a first option to install the one application on a user device and a second option to run the one application without installing the one application on the user device;
receiving a user selection of the second option or the first option for the one application;
running, in response to user selection of the second option, the one application on a virtual machine remote from the user device without installing the one application on the user device; and
providing, in response to user selection of the first option, the application to the user device for installation on the user device.

16. The system as recited in claim 15, the running the one application on the virtual machine without installing the one application on the user device including:
receiving data describing a user interface display from the one application running on the virtual machine and providing the data to the user device for presentation of the user interface display at the user device; and
receiving, from the user device, data describing user input to the user interface display and providing the data describing the received user input to the one application running on the virtual machine.

17. The system as recited in claim 15, the acts further comprising:
determining a form factor of the user device;
selecting one of multiple virtual machines that correspond to the form factor of the user device, each of the multiple virtual machines corresponding to a different one of multiple user device form factors; and
running the one application on the selected virtual machine.

18. The system as recited in claim 15, the acts further comprising saving user data for the one application running on the virtual machine as associated with a user of the user device and the one application.

19. The system as recited in claim 18, the acts further comprising:
obtaining, when the one application is again run on the virtual machine, the saved user data; and
providing the saved user data to the one application running on the virtual machine.

20. The system as recited in claim 18, the acts further comprising:
obtaining, in response to user selection of the first option, the saved user data; and
providing the saved user data to the one application installed on the user device.
